(19) United States
(12) Patent Application Publication
(10) Pub. No.: US 2026/0158463 A1
(43) Pub. Date: Jun. 11, 2026

(54) METHOD AND SYSTEM FOR PRODUCING CORE-SHELL MICROCAPSULES FOR DOWNHOLE APPLICATIONS USING MICROFLUIDIC-BASED SOLVENT EVAPORATION

(71) Applicant: SAUDI ARABIAN OIL COMPANY, Dhahran (SA)

(72) Inventors: Maxim Orlov, Moscow (RU); Iaroslav Rybkin, Moscow (RU); Abdullah S. Al-Yami, Dhahran (SA)

(73) Assignees: SAUDI ARABIAN OIL COMPANY, Dhahran (SA); Aramco Innovations LLC, Moscow (RU)

(21) Appl. No.: 18/708,751

(22) PCT Filed: Jul. 11, 2023
(86) PCT No.: PCT/RU2023/000206

§ 371 Date: May 9, 2024

(51) Int. Cl. B01J 13/12; C09K 8/512; C09K 8/516; E21B 21/00; E21B 21/06

(52) U.S. Cl. CPC B01J 13/125; C09K 8/512; C09K 8/516; E21B 21/003; E21B 21/062

(57) ABSTRACT

A system includes: a plurality of syringe pumps that provide an aqueous solution including a stabilizer, a non-aqueous solution including a polymer dissolved in an organic liquid, and a curing agent; a microchannel network; and an evaporation unit that provides an elevated temperature so that the organic liquid in the emulsion evaporates and microcapsules form. The microchannel network includes: a plurality of channels that separately receive the aqueous solution and the non-aqueous solution from the syringe pumps; and at least one channel junction where the aqueous solution and the non-aqueous solution mix to form an emulsion. Each of the microcapsules has a shell including the polymer and a core including the curing agent.

### BACKGROUND

A microcapsule is a spherical particle having a size varying from nanometers to a few millimeters and comprising a near-uniform wall enclosing a material. The enclosed material in the microcapsule may be referred to as the core, internal phase, or fill, whereas the wall may be referred to as a shell, coating, or membrane.

Conventionally, microcapsules may be prepared by physical methods (e.g., spray drying and congealing, fluidized bed coating, electrostatic based, vibration nozzle, hot-melt extrusion, solvent evaporation), chemical methods (e.g., emulsion polymerization, interfacial polycondensation, interfacial cross-linking), and physical-chemical methods (e.g., coacervation, layer-by-layer adsorption).

Microcapsules may be used in downhole applications, including gas or water shutoff and lost circulation prevention operations. There exists a need to develop microcapsule production that ensures scalability and high loading of materials of interest.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In some aspects, one or more embodiments described herein relate to a system, including: a plurality of syringe pumps that provide an aqueous solution including a stabilizer, a non-aqueous solution including a polymer dissolved in an organic liquid, and a curing agent; a microchannel network including: a plurality of channels that separately receive the aqueous solution and the non-aqueous solution from the syringe pumps; and at least one channel junction where the aqueous solution and the non-aqueous solution mix to form an emulsion; and an evaporation unit that provides an elevated temperature so that the organic liquid in the emulsion evaporates and microcapsules form, wherein each of the microcapsules includes a shell including the polymer and a core including the curing agent.

In some aspects, one or more embodiments described herein relate to a system, wherein the curing agent is selected from the group consisting of an amine-based curing agent, an anhydride-based curing agent, a mercaptan-based curing agent, and combinations thereof.

In some aspects, one or more embodiments described herein relate to a system, wherein the curing agent is dissolved in the non-aqueous solution including the polymer.

In some aspects, one or more embodiments described herein relate to a system, wherein the curing agent is dissolved in the aqueous solution including the stabilizer.

In some aspects, one or more embodiments described herein relate to a system, wherein the curing agent is provided to the microchannel network separately from the stabilizer and the polymer.

In some aspects, one or more embodiments described herein relate to a system, wherein the emulsion formed in the microchannel network is an oil-in-water emulsion having a continuous phase including the stabilizer and water and a dispersed phase including the polymer, the curing agent, and the organic liquid.

In some aspects, one or more embodiments described herein relate to a system, wherein the emulsion formed in the microchannel network is a water-in-oil emulsion having a continuous phase including the polymer and the organic liquid, and a dispersed phase including the stabilizer, the curing agent, and water.

In some aspects, one or more embodiments described herein relate to a system, wherein the microchannel network and the evaporation unit are disposed on a plate that is temperature controlled.

In some aspects, one or more embodiments described herein relate to a system, wherein the evaporation unit includes a gas-permeable membrane configured to separate evaporated organic liquid.

In some aspects, one or more embodiments described herein relate to a system, wherein the gas-permeable membrane is arranged as a layer in a reservoir of the evaporation unit.

In some aspects, one or more embodiments described herein relate to a system, wherein the gas-permeable membrane is arranged as a pipe disposed in a casing providing a vacuum environment

In some aspects, one or more embodiments described herein relate to a method, including: providing aqueous solution including a stabilizer, a non-aqueous solution including a polymer dissolved in an organic liquid, and a curing agent; forming an emulsion by mixing the aqueous solution, the non-aqueous solution, and the curing agent in a microchannel network including a plurality of microchannels and at least one microchannel junction, evaporating the organic liquid in the emulsion under an elevated temperature to form microcapsules, wherein each of the microcapsules includes a shell including the polymer and a core including the curing agent; and introducing the microcapsules downhole

In some aspects, one or more embodiments described herein relate to a method, further including separating evaporated organic liquid using a gas-permeable membrane.

In some aspects, one or more embodiments described herein relate to a method, further including providing a vacuum to remove evaporated organic liquid.

Other aspects and advantages of the claimed subject matter will be apparent from the following description and the appended claims.

### BRIEF DESCRIPTION OF DRAWINGS

FIG. 1 shows a system according to one or more embodiments.

FIG. 2 shows an evaporation unit in a system disclosed herein according to one or more embodiments (top view),

FIG. 3 shows an evaporation unit in a system disclosed herein according to one or more embodiments (side view)

FIG. 4 shows an evaporation unit in a system disclosed herein according to one or more embodiments (side view).

FIG. 5 shows an evaporation unit in a system disclosed herein according to one or more embodiments (top view).

FIG. 6 shows an evaporation unit in a system disclosed herein according to one or more embodiments (top view).

FIG. 7 shows a flowchart of a method according to one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

In one aspect, embodiments disclosed herein relate to systems and methods of preparing microcapsules and using microcapsules in downhole applications. The systems and methods disclosed herein may provide efficient production of uniform tailor-made microcapsules with a high loading capacity and close size distribution, based on solvent evaporation in combination with microfluidics technique.

The microcapsules disclosed herein may be used for downhole applications, such as gas/water shutoffs and lost circulation prevention operations. The need of such operations arises from uncontrolled seepage of drilling fluid or excessive water and/or gas production through highly permeable, porous, cavernous, vuggy, fissured, or fractured formations during wellbore operations. Such formations may include shale beds, reef deposits, limestone, dolomite, shale, sands, gravel, and chalk, with a high uptake capacity of drilling fluid. Gas or water shutoff focuses on eliminating unwanted gas or water production, which may cause reduced oil production, poor sweep efficiency, presence of scales, corrosion, and degradation in wellbore and surface facilities, and extra cost in separating, treating, and disposing the unwanted gas or water. Lost circulation is a complex downhole situation in which working fluid may leak into formation during drilling, which may cause delayed drilling, loss of drilling fluid, damage to oil and gas reservoir, and wellbore instability, and consequently result in a series of complex accidents, such as well collapse, jamming of drilling tools, and well blowout. Lost circulation and water/gas shutoffs are recurring, time, labor, and resource-demanding problems, which call for the development of methods for their mitigation. These problems result in extremely high losses of drilling materials and need for additional water purification, as well as lowered oil production and formation of inaccessible oil pockets.

The lost circulation or excessive gas/water production may be reduced by introduction of one or more epoxy-based resins that can be cured and thereby hardened downhole with a curing agent. The microcapsules described herein encapsulate such curing agents for delivery downhole. Therefore, epoxy-based resins and encapsulated curing agent are preserved in a liquid state being isolated from each other and can be activated (cured) only at the site of interest. For this purpose, the curing agent is entrapped in the microcapsules, where a shell containing a polymer keeps an encapsulated core containing the curing agent isolated from epoxy-based resins. As a result, it ensures the coring of epoxy-based resins only at a given time when activated by an external source, without interfering with inflow and productivity of the borehole.

Thus, the present disclosure provides systems and methods for making microcapsules and for effective delivery of curing agents downhole In one or more embodiments, the present disclosure provides systems and methods for making microcapsules that include a shell containing a polymer and a core containing a curing agent. According to one or more embodiments, the system disclosed herein includes: two or more syringe pumps, each containing a solution to be supplied to a microchannel network, the microchannel network for formation of an emulsion, and an evaporation unit, which allows solvent evaporation under an elevated temperature for formation of microcapsules.

An “emulsion” is a mixture of two or more liquids that are normally immiscible (unmixable or unblendable) owing to liquid-liquid phase separation, one. The emulsion is generally liquid, with one liquid dispersed in another, Two liquids, for example an aqueous solution and a non-aqueous solution, can form different types of emulsions. The formed emulsion may have two phases: a dispersed phase (in form of nearly spherical droplets) and a continuous phase (in form of liquid surrounding the droplets). The emulsion is an oil-in-water (O/W) emulsion if the dispersed phase is a non-aqueous solution containing an organic liquid (an “oil”) and the continuous phase is an aqueous solution. Alternatively, the emulsion is a water-in-oil (W/O) emulsion if the dispersed phase is an aqueous solution, and the continuous phase is a non-aqueous solution containing an organic liquid. Multiple emulsions are also possible, such as but not limited to, a “water-in-oil-in-water” (W/O/W) emulsion and an “oil-in-water-in-oil” (O/W/O) emulsion. In the present disclosure, an “oil” phase, if not otherwise specified. refers to the non-aqueous solution described in one or more embodiments of the present disclosure. A “water” phase, if not otherwise specified, refers to the aqueous solution described in one or more embodiments of the present disclosure.

Specific embodiments of the system will now be described in detail with reference to the accompanying sures. Like elements in the various figures are denoted by like reference numerals for consistency. While only a limited number of examples are shown in the figures, it is recognized to one having ordinary skill in the art that the examples are non-limiting and components described herein may be modified. For example, components may have any desired shape and dimension.

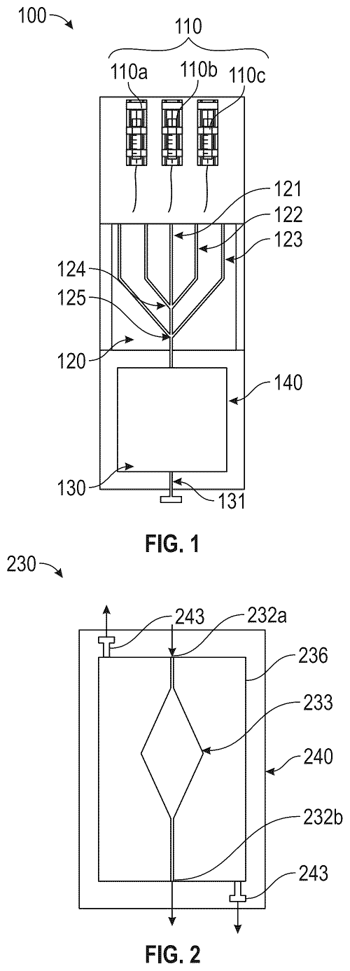

FIG. 1 shows a non-limiting example of the system according to one or more embodiments. The system 100 includes two or more syringe pumps 110, a microchannel network 120, and an evaporation unit 130. Each of the syringe pumps 110 contains a solution, for example, an aqueous solution comprising a stabilizer and water, or a non-aqueous solution comprising a polymer and an organic liquid. A curing agent may be held in one of the syringe pumps, dissolved in water, or an organic liquid, or used pure without any solvent, The curing agent may be dissolved together with the stabilizer in the aqueous solutions, or may be dissolved together with the polymer in the non-aqueous solutions. According to one or more embodiments, the syringe pumps 110 in the system disclosed herein may be configured to operate in a controlled manner. Each of the syringe pumps 110 may be individually controlled to operate at certain temperature and/or flow rate. In one or more embodiments, a temperature of the syringe pumps ranges from about 5° C. to about 150° C., based on solvent boiling points. In one or more embodiments, a flow rate of the syringe pumps ranges from about I microliter per minute (ml/min) to about 50 mL/min. As a result, the syringe pumps allow constant feeding of the solutions to the microchannel network 120.

According to one or more embodiments, the microchannel network 120 includes a plurality of channels, each allowing flow of one or more solutions, and at least one channel junction, where two or more channels converge. The solutions flow in a plurality of channels of the microchannel network 120, for example, channels 121, 122. and 123. At a channel junction 124, immiscible solutions in channels 121 and 122 converge, and the immiscible solutions are mixed at the channel junction to form an emulsion. An angle between channel 121 and channel 122 may be from about 10° to about 90°, or from about 30° to about 60°, such that the flows of the immiscible solutions in the two converging channels maintain in an optimal direction and speed. The emulsion formed at the channel junction 124 may be a two-phase emulsion, for example, a W/O emulsion or an O/W emulsion. Another channel 123 may supply another solution to converge with the two-phase emulsion at another channel junction 125 to form a multiple emulsion, for example, a W/O/W emulsion or an O/W/O emulsion.

The emulsion formed in the microchannel network 120 may flow to the evaporation unit 130 for evaporation of the organic liquid. The evaporation unit 130 may comprise a reservoir and/or a gas-permeable membrane. The microchannel network 120 and/or the evaporation unit 130 may be located on a plate 140 with temperature control. At the evaporation unit 130, the organic liquid is evaporated and microcapsules form. A vacuum line may be coupled to the evaporation unit to remove the gas containing evaporated organic liquid from the system and to collect the evaporated organic liquid for reuse. The formed microcapsules are collected at a colleting point 131. The microchannel network 120 and the evaporation unit 130 may be fabricated on a microfluidies chip.

In one or more embodiments, the system includes at least a first syringe pump 110a containing an aqueous solution, in which the solvent is water, and a second syringe pump 110b containing a non-aqueous solution, in which one or more materials of interest (e.g., a curing agent and/or a polymer) are used without solvent or dissolved in an organic liquid. The organic liquid may be a volatile organic compound selected from the group consisting of a dichloromethane, a dichloroethane, an acetone, a butanone, an acetic acid, a cyclopentane, an ethyl acetate, a carbon disulfide, an ethanol, an isopropanol, a propanol, a formaldehyde, a chloroform, a carbon tetrachloride, a hexane, a heptane, an octane, a benzeno, a toluene, an acetonitrile, a 1,4-dioxane, a dimethyl sulphide, a tetrahydrofuran, a diethyl ether, and mixtures thereof. In one or more embodiments, the system may include three or more syringe pumps 110a, 110b, and 110c, etc., each containing an aqueous solution or a non-aqueous solution, based on needs of desired microcapsule production. For example, the system may include three syringe pumps, one of which contains an aqueous solution, and two of which contain non-aqueous solutions dissolved in same or different organic liquids. In another example, the system may include three syringe pumps, one of which contains an aqueous solution, one of which contains a non-aqueous solution dissolved in an organic liquid, and one of which contains a material of interest without addition of solvent

In one or more embodiments, at least one of the solutions comprises a stabilizer, configured to stabilize the emulsion until the microcapsules are formed. The stabilizer reduces an interfacial tension between two immiscible phases, for example, oil and water. The stabilizers are typically amphiphilic molecules that are both hydrophilic (water-loving) and hydrophobic (water-repelling) regions. When the stabilizer is presence in the emulsion, the hydrophobic regions of the stabilizer molecules adsorb on the emulsion interface orienting water-repelling region in the oil phase, while the hydrophilic regions extend into the aqueous phase, thus creates a layer of stabilizer molecules around the droplets, which reduces the interfacial tension and stabilizes the droplets. That is, the stabilizer maintains a dispersed state of the emulsion over time, In addition, the stabilizer may spatially prevent droplets from coming into contact with each other. Examples of the stabilizer may include non-ionic surfactants selected from the group consisting of fatty acids, amino alcohols, fatty alcohols, fatty mercaptans, polyethylene glycol, polypropylene glycol, polyvinyl alcohol, fatty acid esters of sorbitol, fatty acid esters of glycerol, fatty acid esters of polyhydroxy compounds, alkylphenol ethoxylates, alkyl polyglucosides, fatty alcohol ethoxylates, ethoxylated amines, fatty acid amides, and mixtures thereof. According to one or more embodiments, the stabilizer may be dissolved in water, and a solution comprising the stabilizer is an aqueous solution.

In one or more embodiments, at least one of the solutions comprises a polymer. The polymer may be a thermoplastic. The polymer may be selected from the group consisting of poly(methyl methacrylate), polymethacrylate, poly(lactic-co-glycolic acid), adipate polyesters, polyester, polystyrene, poly(styrene-isoprene), polybromostyrene, polyethylene, polyphenylene oxide, polyether sulfone, acrylonitrile butadiene styre polybutadiene, polybutylene succinate, polycaprolactone, polycarbonate, polyhydroxyalkanoate, polyhydroxybutyrate, polylactic acid, polyurethane, polyvinyl chloride, styrene butadiene, wax, acenaphthylene, cellulose acetate, cellulose trinitrate, a poly(methyl methacrylate) based copolymer, a polymethacrylate based copolymer, a poly(lactic-co-glycolic acid) based copolymer, a adipate polyesters based copolymer, a polyester based copolymer, a polystyrene based copolymer, a poly(styrene-isoprene) based copolymer, a polybromostyrene based copolymer, a polyethylene based copolymer, a polyphenylene oxide based copolymer, a polyether sulfone based copolymer, a acrylonitrile butadiene styrene based copolymer, a polybutadiene based copolymer, a polybutylene succinate based copolymer, a polycaprolactone based copolymer, polycarbonate based copolymer, a polyhydroxyalkanoate based copolymer, a polyhydroxybutyrate based copolymer, a polylactic acid based copolymer, a polyurethane based copolymer, a polyvinyl chloride based copolymer, a styrene butadiene based copolymer, wax, an acenaphthylene based copolymer, and mixtures thereof.

In one or more embodiments, the polymer is water insoluble. As a result, the polymer is dissolved in one or more of the organic liquids previously described, and a solution containing the polymer is a non-aqueous solution. Dissolution of the polymer may be performed under room temperature, or under elevated temperature as needed. depending on the type of polymer and solvent of the solution. In one or more embodiments, a concentration of the polymer in the solution ranges from about 0.5 weight percentage (wt %) to about 40 wt %, or from about 5 wt % to about 20 wt %. The concentration of the polymer may affect a size or a size distribution of the emulsion or microcapsule via collision of droplets. The concentration of the polymer may affect an encapsulation efficiency by affecting a ratio of core material versus shell material. The concentration of the polymer may affect a stability of the emulsion or microcapsule formed, for example, how the emulsion or microcapsules settle under gravity. The concentration of the polymer may affect release of the microcapsules in various applications by changing diffusion of the microcapsules.

In one or more embodiments, at least one of the solutions comprises a curing agent. The curing agent may include an amine type curing agent, such as a low molecular weight amine compound having a primary-, secondary-, tertiary, and/or quaternary amino group, for curing epoxy-based resins. In one or more embodiments, the curing agent includes a low molecular weight amine compound having a primary amino group. The curing agent may include ethylenediamine, diethylenetriamine, triethylenetetramine, tetraethylenepentamine, hexamethylenediamine, isophorone diamine, bis(4-amino-3-methylcyclohexyl)methane, diaminodicyclohexylmethane, m-xylenediamine, diaminodiphenylmethane, diaminodiphenylsulfone, phenylenediamine, and mixtures thereof. The curing agent may include guanidines such as dicyandiamide, methylguanidine, ethylguanidine, propylguanidine, butylguanidine, dimethylguanidine, trimethylguanidine, phenylguanidine, diphenylguanidine, toluylguanidine, and mixtures thereof. The curing agent may include acid hydrazides such as succinic acid dihydrazide, adipic acid dihydrazide, phthalic acid dihydrazide, isophthalic acid dihydrazide, terephthalic acid dihydrazide, p-hydroxybenzoic acid hydrazide, salicylic acid hydrazide, phenylaminopropionic acid hydrazide, maleic acid dihydrazide, and mixtures thereof. In one or more embodiments, the curing agent includes a low molecular weight amine compound having a secondary amino group The curing agent may include piperidine, pyrrolidine, diphenylamine, 2-methylimidazole, 2-ethyl-4-methylimidazole, and mixtures thereof. In one or more embodiments, the curing agent includes a low molecular weight amine compound having a tertiary amino group. The curing agent may include imidazoles such as 1-cyanoethyl-2-undecylimidazole-trimellitate, imidazolylsuccinic acid, 2-methylimidazole-succinic acid, 2-etliylimidazole-succinic acid, 1-cyanoethyl-2-ethylimidazole, 1-cyanoethyl-2-undecylimidazole, 1-cyanoethyl-2-phenylimidazole, and mixtures thereof.

In one or more embodiments, the curing agent comprises an anhydride-based curing agent. The anhydride-based curing agent may contain one or more of maleic anhydride, phthalic anhydride, trimellito anhydride, pyromellitic anhydride, tetrahydrophthalic anhydride, methyltetrahydrophthalic anhydride, dodecenyl succinic anhydride, endomethylene tetrahydrophthalio anhydride, methylbutenyl tetrahydrophthalic anhydride, hexahydrophthalic anhydride, hexahydro-4-methylphthalie anhydride, alkylstyrene-maleic anhydride, succinic anhydride, methylcyclohexene dicarboxylic anhydride, chlorendic anhydride, ylene glycol bistrimellitate, glycerol tristrimellitate, benzophenone tetracarboxylic anhydride, and mixtures thereof.

In one or more embodiments, the curing agent comprises a mercaptan-based curing agent. The mercaptan-based curing agent may contain one or more of methylene bis phenyl dimethylurea, methyl-m-phenylene bis 3,3-dimethylurea, 3-(4-chlorophenyl)-1,1-dimethylurea, and mixtures thereof.

In one or more embodiments, the curing agent comprises an amine-based curing agent. The amine-based curing agent may contain one or more of bisphenol-A-epichlorohydrin epoxy resin with the reactive diluent oxirane mono [(C12-C14)-alkyloxy)methyl] derivatives; C12-C14 alkyl glycidyl ether; 2,3-epoxypropyl-o-tolyl ether: 1,6-hexanediol diglycidyl ether; bisphenol-A/epichlorohydrin resin and butyl glycidyl ether resin: bisphenol-A/epichlorohydrin and butyl glycidyl ether and cyclohexanedimethanol resins: cyclohexanedimethanol diglydicyl ether; diethylenetriamine (DETA); diethyltoluenediamine; dolyoxypropylene diamine, and mixtures thereof.

In one or more embodiments, an aqueous solution comprising a stabilizer and a non-aqueous solution comprising a polymer converge at a channel junction to form an O/W emulsion (a continuous phase comprising a stabilizer dissolved in water and a dispersed phase comprising a polymer dissolved in organic liquid). The curing agent and the polymer may be dissolved in a same non-aqueous solution with the polymer.

In one or more embodiments, an aqueous solution comprising a stabilizer and a non-aqueous solution comprising a polymer converge at a channel junction to form a W/O emulsion (a continuous phase comprising a polymer dissolved in organic liquid and a dispersed phase comprising a stabilizer dissolved in water). The curing agent and the polymer may be dissolved in a same aqueous solution with the stabilizer.

In one or more embodiments, the curing agent may be dissolved in a solution separate from the stabilizer and the polymer, and may be dissolved in water or organic liquids. In one or more embodiments, if the curing agent is immiscible with the solvents, the curing agent can be us without solvent, and the solution comprising the curing agent consists essentially of the curing agent.

In one or more embodiments, the emulsion may be a multiple phase emulsion having an internal continuous phase comprising the curing agent, used pure without solvent or dissolved in water, a dispersed phase comprising a polymer dissolved in organic liquid, and an external continuous phase comprising a stabilizer dissolved in water.

According to one or more embodiments, a type of the emulsion formed at any of the channel junctions in the system may be dependent on a relative amount of the aqueous solution versus the non-aqueous solution. For example, one solution that is in excess amount may be the continuous phase and the other solution may be the dispersed phase. Alternatively, the type of the emulsion may be dependent on the type of solvent in the non-aqueous solution.

According to one or more embodiments, flow rates of the aqueous solution and the non-aqueous solution may affect ze and distribution of droplets in the resulting emulsion. For example, increasing a flow rate of one phase relative to the other may lead to smaller droplets due to a shorter time available for the droplets to form before being carried away by the flow. Dimensions of the channels may also influence the formation of emulsion. For example, a smaller channel generally results in smaller droplets due to a greater shear force and turbulence generated by the flow of the phases. However, a smaller channel may also lead to increased channel blockage and may potentially be more challenging to fabricate and operate.

The microchannel network may be fabricated on a microfluidics chip. The material used to fabricate the microfluidics chip may include: silicon, glass, polymers (e.g., PDMA, PMMA), ceramics, semiconductors, and metals. The microfluidics chip map be fabricated in any method that is known to one having ordinary skill in the art, for example, micromilling, etching, soft lithography, or 3D printing. The microfluidics chip may have a size as desired and may be adjusted based on types of solutions, concentration of materials in the solutions, flow rate, or other materials and parameters that influence the formation of microcapsules. In one or more embodiments, the microfluidics chip may have a length of about 1 cm to about 15 cm and a width of about 1 cm to about 15 cm. Each channel in the microchannel network may have a width and a height of about 1 micrometer to about 1 cm and a length of about 5 mm to 5 cm.

According to one or more embodiments, the emulsion formed in the microchannel network is directed to the evaporation unit, where the organic liquid in the emulsion evaporates and microcapsules form. The evaporation unit may be coupled to a plate with temperature control, configured to provide an elevated temperature to increase an evaporate rate of the organic liquid. The evaporation unit may be coupled t a vacuum pump configured to generate a gradient of low pressure, so as to facilitate evaporation of the organic liquid and enable reuse of the organic liquid.

According to one or more embodiments, the evaporation unit comprises a reservoir. In one or more embodiments, the reservoir may be fabricated as a void space on a microfluidics chip. The microchannel network and the evaporation unit may be fabricated on the same microfluidics chip. Various shapes and sizes may be selected for the reservoir and may be optimized so as to balance a rate of emulsion formation and a rate of evaporation. Constant stirring may be applied to the reservoir to maintain agitation of microcapsules and facilitate evaporation of the organic liquid.

According to one or more embodiments, the evaporation unit comprises a gas-permeable membrane, allowing permeation of gas (containing evaporated organic liquid) only. The gas-permeable membrane may be hydrophobic, so as to prevent the water-containing emulsion from permeating. A pore size of the gas-permeable membrane may be optimized according to a molecular size of the organic liquid to ensure gas permeation. To maximize a rate of gas removal, the gas-permeable membrane may be arranged as a pipe in S-shape. A dimension of the gas-permeable membrane may be determined according to a desired quantity of microcapsule formation and a time required for the microcapsules to be sufficiently hardened, preventing leakage of the encapsulated material. In one or more embodiments, when the vacuum pump is used, the gas-permeable membrane may be arranged inside a casing,

In one or more embodiments, the microcapsules formed after evaporation have a core-shell structure. For example, each microcapsule may have a core comprising the curing agent and a shell comprising the polymer, formed from a W/O emulsion having a continuous phase comprising the polymer dissolved in organic liquid and a dispersed phase comprising the stabilizer and the curing agent dissolved in water.

In one or more embodiments, the microcapsules formed after evaporation have a non-classical core-shell structure. For example, each microcapsule may have a shell comprising the polymer and a core comprising the polymer, in which the polymer smoothly extends from the shell to the core. The curing agent is entrapped in the polymer skeleton/mesh inside the core, formed from an O/W emulsion having a continuous phase comprising the stabilizer dissolved in water and a dispersed phase comprising both the polymer and the curing agent dissolved in organic liquid.

While a limited number of microcapsule configurations are described herein, it is readily recognized to one having ordinary skill in the art that the microcapsules of the present disclosure are not limited to these configurations. For example, when the curing agent is injected to the microchannel network in a solution separate from the stabilizer and the polymer, the formed emulsion may depend on amount of each solution, concentration of materials, type of materials or organic liquids involved, or other parameters during formation, and thus resulting in various configurations of the microcapsules with encapsulated or entrapped curing agent. According to one or more embodiments, a size of the microcapsules formed in the present disclosure ranges from about 10 μm to about 1 mm. Materials and parameters used the emulsion of microcapsules formation, such as flow rate, viscosity, concentration of polymer, concentration of stabilizer, concentration of curing agent, temperature of evaporation, pressure of evaporation. may affect the microcapsule size and other properties.

Specific embodiments of the evaporation unit in the system according to one or more embodiments may now be described in detail with reference to FIGS. 2-6. While only a limited number of embodiments are shown in the figures, it is recognized to one having ordinary skill in the art that the examples are non-limiting and components described herein may be modified.

FIG. 2 shows a non-limiting example of an evaporation unit according to one or more embodiments disclosed herein (top view). The evaporation unit 230 comprises an inlet 232a configured to receive an emulsion from a microchannel network and an outlet 232b configured to guide the formed microcapsules out. The emulsion is incubated in a reservoir 233 that is covered by a casing 236, in which a vacuum environment is provided. Organic liquid in the emulsion evaporates under an elevated temperature controlled by a plate 240. The gas containing evaporated organic liquid is removed by one or more vacuum lines 243 that are connected to the c sing 236 and are controlled by a vacuum pump and/or a valve. While only one shape of the reservoir is shown in FIGS. 1 and 2, it is recognized to one having ordinary skill in the art that the shape and size of the reservoir may be any shape and size as needed.

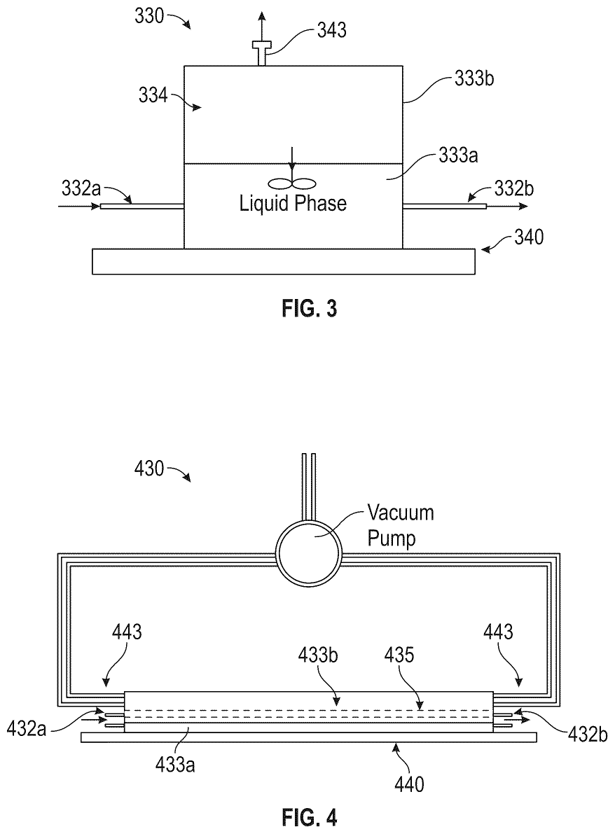

FIG. 3 shows a non-limiting example of an evaporation unit according to one or more embodiments disclosed herein (side view). The evaporation unit 330 comprises an inlet 332a configured to receive an emulsion from a microchannel network and an outlet 332b configured to guide the formed microcapsules out. Organic liquid in the emulsion evaporates under an elevated temperature controlled by a plate 340. The emulsion is in liquid phase and occupies a bottom portion of a reservoir 333a. A gas containing evaporated organic liquid occupies a top portion of the reservoir 333b. A stir 334 is used to provide agitation to the emulsion. The gas containing evaporated organic liquid is removed by a vacuum line 343 controlled by a vacuum pump and/or a valve.

FIG. 4 shows a non-limiting example of an evaporation unit according to one or more embodiments disclosed herein (side view). The evaporation unit 430 comprises an inlet 432a configured to receive an emulsion from a microchannel network and an outlet 432b configured to guide the formed microcapsules out. Organic liquid in the emulsion evaporates under an elevated temperature controlled by a plate 440. The emulsion is in liquid phase and occupies a bottom portion of a reservoir 433a. A gas containing evaporated organic liquid occupies a top portion of the reservoir 43b. A gas-permeable membrane 435 is arranged horizontally as a layer in the top portion of the reservoir 433b, allowing permeation of gas phase only, The gas-permeable membrane may have a size that is substantially the same as a size of the reservoir. The gas containing evaporated organic liquid is removed by one or more vacuum lines 443 controlled by a vacuum pump and/or a valve.

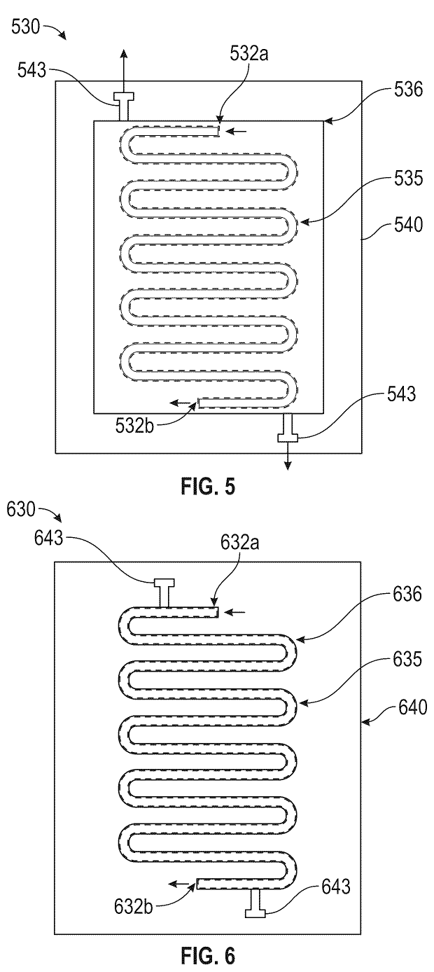

FIG. 5 shows a non-limiting example of an evaporation unit according to one or more embodiments disclosed herein (top view). The evaporation unit 530 comprises an inlet 532a configured to receive an emulsion from a microchannel network and an outlet 532b configured to guide the formed microcapsules out. The emulsion is incubated in a gas-permeable membrane 535 that is covered by a casing 536, in which a vacuum environment is provided. Organic liquid in the emulsion evaporates under an elevated temperature controlled by a plate 540. The gas containing evaporated organic liquid is separated by the gas-permeable membrane 535 and subsequently removed by one or more vacuum lines 543 that are connected to the casing 536 and are controlled by a vacuum pump and/or a valve. The gas-permeable membrane 535 may have any desired dimension (for example, diameter or length) and may be arranged to have any desired shape. For example, in the non-limiting example of FIG. 5, the gas-permeable membrane is arranged as a pipe in S-shape, so as to increase a length of the gas-permable membrane and to increase a contact surface area of the emulsion with the gas-permeable membrane,

FIG. 6 shows a non-limiting example of an evaporation unit according to one or more embodiments disclosed herein (top view). The evaporation unit 630 comprises an inlet 632a configured to receive an emulsion from a microchannel network and an outlet 632b configured to guide the formed microcapsules out. The emulsion is incubated in a gas-permeable membrane 635. Organic liquid in the emulsion evaporates under an elevated temperature controlled by a plate 640. The gas containing evaporated organic liquid is separated by the gas-permeable membrane 635 and subsequently removed by one or more vacuum lines 643 controlled by a vacuum pump and/or a valve. The gas-permeable membrane 635 may have any desired dimension (for example, diameter or length) and may be arranged to have any desired shape. For example, in the non-limiting example of FIG. 6, the gas-permeable membrane is arranged as a pipe in S-shape, so as to increase a length of the gas-permeable membrane and to increase a contact surface area of the emulsion with the gas-permeable membrane. The gas-permeable membrane is disposed inside a casing 636, and the vacuum lines 643 may be connected to the casing 636.

The system according to one or more embodiments disclosed herein may include a control unit configured to control one or more parameters in the system and to obtain, process, and transfer any data associated with the system. The control unit may individually control one or more components of the system, such as each of the syringe pumps, the microchannel network, the evaporation unit, and any other coupling. structure. The control unit may individually control one or more parameters at one of more positions of the system, such as a temperature, a flow mate, a number of channels in use, and a pressure generated by the vacuum pump. The one or more parameters may be determined and regulated based on desired formation of emulsion or microcapsules. The control unit may include one or more sensors for obtaining data on the one or more parameters, for example, a thermocouple, a pressure gauge, a flow meter, or others. The control unit may include an imaging control function that enables visually controlled microcapsule formation.

According to one or more embodiments, the control unit may include a computing device, providing computational functionalities associated with algorithms, methods, functions, processes, flows, an procedures as described in one or more embodiments of the present disclosure.

According to one or more embodiments, the computing device is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computing device may include a computer that includes an input device, such as a keypad, keyboard, touch screen, or other device that can accept user information, and an output device that conveys information associated with the operation of the computing device, including digital data, visual, or audio information (or a combination of information), or a GUI.

At a high level, the comp g device may be an electronic computing device operable to receive, transmit, process, store, or manage data and information associated with the described subject matter. According to some implementations, the computing device may also include or be communicably coupled with an application server, e-mail server, web server, caching server, streaming data server, business intelligence (BI) server, or other server (or a combination of servers). In one or more embodiments, the computing device includes at least one processor. Generally, the processor executes instructions and manipulates data to perform the operations of the computing device and any algorithms, methods, functions, processes, flows, and procedures as described in the instant disclosure. In one or more embodiments, the computing device Includes a memory that holds data for the computing device. For example, the memory can be a database storing data consistent with this disclosure. In one or more embodiments, the computing device includes an application, which is an algorithmic software engine providing functionality according to particular needs, desires, or particular implementations of the computing device, particularly with respect to functionality described in the present disclosure.

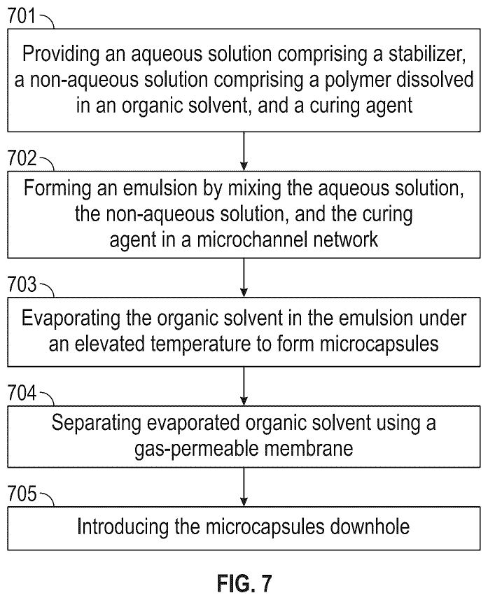

Embodiments disclosed herein may also relate to a method of preparing microcapsules and using microcapsules in downhole applications. The method may include one or more steps as shown in a flowchart of FIG. 7. One or more blocks in FIG. 7 may be performed by the system describe herein or by one or more components as described in FIGS. 1-6. While the various blocks in FIG. 7 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

The method may comprise a step 701, in which a plurality of solutions, for example, an aqueous solution and a non-aqueous solution, are prepared and arranged in syringe pumps. The aqueous solution may comprise a stabilizer and water. The non-aqueous solution may comprise a polymer and an organic liquid. In one or more embodiments, the non-aqueous further comprises a curing agent. Alternatively, the curing agent may be contained in another solution, in which the curing agent is dissolved in water or organic liquid, or the curing agent is used without any solvent.

The method may comprise a step 702, in which an emulsion is formed by mixing the plurality of solutions in a microchannel network. The emulsion may be a two-phase emulsion, such as a W/O emulsion or an O/W emulsion, or a multiple-phase emulsion, such as a W/O/W emulsion or an O/W/O emulsion. In one or more embodiments, the emulsion has a continuous phase comprising a stabilizer dissolved in water and a dispersed phase comprising a polymer dissolved in organic liquid. The dispersed phase may further comprise a curing agent. In one or more embodiments, the emulsion has an internal continuous phase comprising a curing agent, used without solvent or dissolved in water, a dispersed phase comprising a polymer dissolved in organic liquid, and an external continuous phase comprising a stabilizer dissolved in water.

The method may comprise a step 703, in which the organic liquid in the emulsion is evaporated, in an evaporation unit, to form microcapsules. The evaporating may be performed under an elevated temperature using a plate with temperature control. The evaporating may be performed under vacuum. Constant stirring may be applied during evaporating to provide agitation to the emulsion and facilitate the evaporating, In one or more embodiments, the microcapsules may have a core-shell structure after the evaporation step. For example, the microcapsules may have a core comprising curing agent and a shell comprising a polymer.

The method may comprise a step 704, in which the evaporated organic liquid, in gas form, is separated through a gas-permeable membrane. The gas-permeable membrane may have any desired dimension (for example, diameter or length) and may be arranged to have any desired shape. For example, the gas-permeable membrane may be arranged as a pipe in S-shape, so as to increase a length of the gas-permeable membrane and to increase a contact surface area of the emulsion with the gas-permeable membrane.

The method may comprise a step 705, in which the microcapsules are introduced downhole. The microcapsules disclosed herein may be used for downhole applications, such as gas/water shutoff's and lost circulation prevention operations. The microcapsules may be introduced downhole with resins, simultaneously or in order. The resins may be epoxy-based resins, such as bisphenol A epoxy, Novolac epoxy, or phenalkamine epoxy. A curing time of epoxy-based resins may vary depending on factors such as temperature, mixing ratio, and hardener type, and may range from a few minutes to a few hours, depending on the application and required properties. The microcapsules encapsulating the curing agent and the resins may be preserved in a liquid state being isolated from each other and activated (cured) only at a downhole site of interest. The core-shell microcapsules, where a shell keeps the encapsulated curing agent (core) isolated from the environment of epoxy resins, prevents immediate reaction of curing epoxy-based resins and ensures the curing (cross-linking) of resins only at a given time by external source, without interfering with the inflow and productivity of the borehole. The curing may be activated by, for example, ultrasound, resulting in breaking of the microcapsule shell and release of the curing agent.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed;

1. A system, comprising:
a plurality of syringe pumps that provide an aqueous solution comprising a stabilizer, a non-aqueous solution comprising a polymer dissolved in an organic liquid, and a curing agent;
a microchannel network comprising:
a plurality of channels that separately receive the aqueous solution and the non-aqueous solution from the syringe pumps; and
at least one channel junction where the aqueous solution and the non-aqueous solution mix to form an emulsion; and
an evaporation unit that provides an elevated temperature so that the organic liquid in the emulsion evaporates and microcapsules form,
wherein each of the microcapsules comprises a shell comprising the polymer and a core comprising the curing agent

2. The system of claim 1, wherein the curing agent is selected from the group consisting of an amine-based curing agent, an anhydride-based curing agent, a mercaptan-based curing agent, and combinations thereof,

3. The system of claim 1, wherein the curing agent is dissolved in the non-aqueous solution comprising the polymer.

4. The system of claim 1, wherein the curing agent is dissolved in the aqueous solution comprising the stabilizer.

5. The system of claim 1, wherein the curing agent is provided to the microchannel network separately from the stabilizer an the polymer.

6. The system of claim 1, wherein the emulsion formed in the microchannel network is an oil-in-water emulsion having a continuous phase comprising the stabilizer and water and a dispersed phase comprising the polymer, the curing agent, and the organic liquid.

7. The system of claim 1, wherein the emulsion formed in the microchannel network is a water-in oil emulsion having a continuous phase comprising the polymer and the organic liquid, and a dispersed phase comprising the stabilizer, the coring agent, and water.

8. The system of claim 1, wherein the microchannel network and the evaporation unit are disposed on a plate that is temperature controlled.

9. The system of claim 1, wherein the evaporation unit comprises a gas-ne le membrane configured to separate evaporated organic liquid.

10. The system of claim 9, wherein the gas-permeable membrane is arranged as a layer in a reservoir of the evaporation unit.

11. The system of claim 9, wherein the gas-permeable membrane is arranged as a pipe disposed in a casing providing a vacuum environment.

12. A method, comprising:
providing an aqueous solution comprising a stabilizer, a non-aqueous solution comprising a polymer dissolved in an organic liquid, and a curing agent;
forming an emulsion by mixing the aqueous solution, the non-aqueous solution, and the curing agent in a microchannel network comprising a plurality of microchannels and at least one microchannel junction;
evaporating the organic liquid in the emulsion under an elevated temperature to form microcapsules, wherein each of the microcapsules comprises a shell comprising the polymer and a core comprising the curing agent; and
introducing the microcapsules downhole,

13. The method of claim 12, further comprising separated organic liquid using a gas-permeable membrane.

14. The method of claim 12, further comprising providing a vacuum to remove evaporated organic liquid.
